(19) United States
(12) Patent Application Publication
(10) Pub. No.: US 2026/0090546 A1
(43) Pub. Date: Apr. 2, 2026

(54) COMBINATIONS OF KETO-ENOL INSECTICIDES

(71) Applicant: Adama Makhteshim Ltd., Beer Sheva (IL)

(72) Inventors: Yogev Dahan, Tene Omarim (IL); Jacob Friedman, Beer Sheva (IL); Erez Meiri, Beit Kama (IL); Daniel Sherman, Jerusalem (IL)

(73) Assignee: Adama Makhteshim Ltd., Beer Sheva (IL)

(21) Appl. No.: 19/113,557

(22) PCT Filed: Sep. 21, 2023
(86) PCT No.: PCT/IL2023/051026

§ 371 Date: Mar. 20, 2025

Related U.S. Application Data
(60) Provisional application No. 63/408,496, filed on Sep. 21, 2022.

(51) Int. Cl. A01N 47/06; A01N 43/12; A01N 43/90; A01N 61/00

(52) U.S. Cl. CPC A01N 47/06; A01N 43/12; A01N 43/90; A01N 61/00

(57) ABSTRACT

The present invention provides a combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

### TECHNICAL FIELD OF THE INVENTION

The present invention relates to novel combinations, compositions and methods comprising keto-enol insecticide and a compound having the formula (I) which provide quick pest kill and excellent control of animal pests.

### BACKGROUND OF THE INVENTION

Spirotetramat is a tetramic acid derivative characterized as a fully systemic insecticide which acts as a lipid biosynthesis inhibitor (Nauen et al., 2008).

Spirotetramat is particularly effective against immature stages of sucking pests such as whiteflies, aphids, psyllids mealybugs and scales; it significantly reduces fecundity and fertility of females of these pests, and consequently reduces insect populations. Spirotetramat also has translocation properties; after foliar uptake the insecticidal activity is translocated within the entire vascular system, i.e. it moves upwards and downwards through its translocation in the xylem and phloem, respectively (Nauen et al 2008).

It is known in the art that spirotetramat does not acts quickly since the control of insect populations is achieved after a period of days and consider having prolong activity (Movento User Guide October 2016). Some of the reasons are time dependent since after the application of the active ingredient, it should be taken up by the plant, transported or translocated to locations where it can affect plant-feeding pests via ingestion.

The efficacy of agrochemicals as crop protection agents is generally a function of the intrinsic properties of the active ingredients, such as their toxicity, plant movement, penetration capacity, and mechanism of action. However, it is also influenced by the formulation and the mode of application of the commercial product which includes solvents and/or solvent mixtures, surfactants and adjuvants among other parameters. Different formulations of the same active ingredient may have different efficacies. This is a result of formulation aids which can alter biological activity of the pesticide by, for example, changing the stability, solubility, crystallization, photochemical degradation, duration of delivery of the active ingredient etc.

It is a great advantage in the agricultural field to obtain combinations, compositions and methods which will provide superior pest kill.

It is also a great advantage in the agricultural field to attain insect control which will provide a quick pest kill as well as long-lasting efficacy.

### SUMMARY OF THE INVENTION

The present invention provides a combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

The present invention also provides a composition comprising keto-enol insecticide, a compound having the formula (I): R1-O—(CmH2mO)x-(CnH2nO)y-H R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and at least one agriculturally acceptable carrier.

The present invention provides a method of treating a plant or a locus against animal pest infestation comprising applying a combination of an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of the keto-enol insecticide is applied alone and/or
(ii) the amount of the compound having the formula (I) improves the insecticidal efficacy of the amount of the keto-enol insecticide compared to when the same amount of the keto-enol insecticide is applied not in combination with the amount of the compound having the formula (I).

The present invention further provides a method for controlling animal pest comprising contacting the animal pest or its environment with an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

The present invention further provides a method for controlling animal pests comprising allowing an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to act on pests and/or their habitat.

The present invention also provides a method of reducing the amount of time needed to achieve a level of animal pest control from an application of an amount of keto-enol insecticide to a plant or locus comprising applying a combination of an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and an amount of keto-enol insecticide to the plant or locus.

The present invention also provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant locus.

### DETAILED DESCRIPTION OF THE INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Throughout the application, descriptions of various embodiments use the term “comprising”; however, it will be understood by one of skill in the art, that in some specific instances, an embodiment can alternatively be described using the language “consisting essentially of” or “consisting of.”

As used herein, the term “a” or “an” includes the singular and the plural, unless specifically stated otherwise. Therefore, the terms “a,” “an” or “at least one” can be used interchangeably in this application.

As use here in, the term “about” is inclusive of the stated value and means within an acceptable range of deviation for the particular value as determined by one of ordinary skill in the art, considering the measurement in question and the error associated with measurement of the particular quantity (i.e. the limitations of the measurement system). For example, “about” can mean within one or more standard deviations, or within ±30%, 20%, 10%, 5% of the stated value. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

As used herein, the term “and/or” includes any and all combinations of one or more of the associated listed items. Expressions such as “at least one of,” when preceding a list of elements, modify the entire list of elements and do not modify the individual elements of the list.

As used herein, the term “combination” means an assemblage of agrochemicals which may be active or non-active ingredients for application either by simultaneous or contemporaneous application.

As used herein, the term “simultaneous” when used in connection with application of agrochemicals means that the agrochemicals which may be active or non-active ingredients are applied in an admixture, for example, a tank mix. For simultaneous application, the combination may be the admixture or separate containers each containing an agrochemical which may be active or non-active ingredient that are combined prior to application.

The admixture or individual components may be in any physical form, e.g. blend, solution, suspension, dispersion, emulsion, alloy, or the like.

As used herein, the term “contemporaneous” when used in connection with application of agrochemicals means that an individual agrochemical which may be active or non-active ingredient is applied separately from another agrochemical or premixture at the same time or at times sufficiently close together that an activity that is additive or more than additive or synergistic relative to the activity of either agrochemical alone at the same dose is achieved. Benefits of applying the keto-enol insecticide with compound having the formula (I), in particular spirotetramat and compound having the formula (I), include, but are not limited to, increased efficacy, bioavailability, penetration, translocation and reducing the amount of time needed to achieve a level of animal pest control of the keto-enol insecticide, in particular spirotetramat.

As used herein, the term “mixture” refers to, but is not limited to, a combination in any physical form, e.g., blend, solution, suspension, dispersion, emulsion, alloy, or the like.

As used herein, the term “tank mix” means one or more of the components of the combination, mixture or composition of the present invention are added are mixed in a spray tank at the time of spray application or prior to spray application.

As used herein, the term “ready mix” means a composition that may be applied to plants directly after dilution. The composition comprises the combination of agrochemicals which may be active or non-active ingredients.

As used herein, the term “composition” includes at least one of the combinations or mixtures of the present invention with agriculturally acceptable carrier.

As used herein, the terms “control” or “controlling” or “treating” means inhibition of animal pest development (including mortality) that causes significant reduction in feeding or other injury or damage caused by the pest; related expressions are defined analogously.

As referred to in this disclosure, the term “animal pest” includes arthropods, gastropods and nematodes of economic importance as pests. The term “arthropod” includes insects, mites, spiders, scorpions, centipedes, millipedes, pill bugs and symphylans. The term “gastropod” includes snails, slugs and other Stylommatophora.

The term “less than 7 days”, as used herein, refers to up to 7 days post application including the seventh day.

The term “between 3 to 7 days”, as used herein, refers to days 3, 4, 5, 6 and 7 (including upper and lower limits post application.

The term “applying” or “application”, as used herein, refers but is not limited to applying the compounds and compositions of the invention to the plant, to a site of infestation by animal pest, to a potential site of infestation by the animal pest, which may require protection from infestation, or the environment around the habitat or potential habitat of the animal pest. The application may be by methods described in the present invention such as by spraying, dipping, etc.

The term “enhancing crop plants” as used herein means improving one or more of plant quality, plant vigor, nutrient uptake, root system, tolerance to stress factors, and/or yield in a plant to which the mixture or composition described herein is applied as compared to a control plant grown under the same conditions except to which the mixture or composition described herein is not applied.

The term “improving plant quality” as used herein means that one or more traits are improved qualitatively or quantitatively in a plant to which the mixture or composition described herein is applied as compared to the same trait in a control plant grown under the same conditions except to which the mixture or composition described herein is not applied. Such traits include but are not limited to improved visual appearance and composition of the plant (i.e. improved color, density, uniformity, compactness), reduced ethylene (reduced production and/or inhibition of reception), improved visual appearance and composition of harvested material (i.e. seeds, fruits, leaves, vegetables, shoot/stem/cane),), improved carbohydrate content (i.e. increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e. improved taste), improved consumer health benefits (i.e. increased levels of vitamins and antioxidants), improved post-harvest characteristics (i.e. enhanced shelf-life and/or storage stability, easier processability, easier extraction of compounds), and/or improved seed quality (i.e. for use in following seasons).

As used herein, the term “effective” when used in connection with any combination, mixture or composition may be but is not limited to increase in controlling animal pest, increase in preventing animal pest infestation, decrease time for effective controlling animal pests, decrease the amount of the compound(s) which is required for effective controlling animal pest.

In particular, the term “effective” may refer to, increasing efficacy of animal pest control in untreated plant area, reducing the amount of time needed to achieve a given level of animal pest control, extending the protection period against animal pest attack and/or reducing the amount of time needed to achieve a level of animal pest control.

As used herein, the term “amount” refers to an amount of the compounds or of the mixture which is sufficient for controlling animal pest on crop plants and does not cause any significant damage to the treated crop plants.

As used herein, the term “agriculturally acceptable carrier” means carriers which are known and accepted in the art for the formation of compositions for agricultural or horticultural use.

As used herein, the term “adjuvant” is broadly defined as any substance that itself is not an active ingredient but which enhances or is intended to enhance the effectiveness of the pesticide with which it is used. Adjuvants may be understood to include, but are not limited to, spreading agents, penetrants, compatibility agents, and drift retardants.

As used herein, the term “agriculturally acceptable additives” is defined as any substance that itself is not an active ingredient but is added to the composition such as thickening agent, sticking agents, surfactants, anti-oxidation agent, anti-foaming agents and thickeners.

As used herein, the term “treated area” refers to an area where the agrochemicals which may be active or non-active ingredients was applied to.

As used herein, the term “untreated area” refers to an area where the insecticide and/or the agrochemicals which may be active or non-active ingredients was not applied to.

As used herein, the term “translocation” is synonymous with the term “migration”.

As used herein the term “plant” or “crop” includes reference to agricultural crops including field crops (soybean, maize, wheat, rice, etc.), vegetable crops (potatoes, cabbages, etc.), fruits (peach, etc.), semi-perennial crops (sugarcane) and perennial crops (coffee and guava).

As used herein the term “plant” or “crop” includes reference to whole plants, plant organs (e.g. leaves, stems, twigs, roots, trunks, limbs, shoots, fruits etc.), plant cells, seedling or plant seeds. This term also encompasses plant crops such as fruits.

As used herein, the term “plants” refers to any and all physical parts of a plant, including but not limited to seeds, seedlings, saplings, roots, tubers, stems, stalks, foliage, and fruits.

The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts, basal shoots, stolons, and buds and other parts of plants, including seedlings and young plants, which are to be transplanted after germination, rooting or after emergence from soil or any other kind of substrate, be it artificial or natural.

As used herein the term “propagation material” is to be understood to denote all the generative parts of the plant such as seeds and spores, vegetative structures such as bulbs, corms, tubers, rhizomes, roots stems, basal shoots, stolons and buds.

As used herein, the term “cultivated plants” includes plants which have been modified by breeding, mutagenesis or genetic engineering. Genetically modified plants are plants, which their genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), shortening of stalks, increased diameter of stalks, increased shoot growth, enhanced plant vigor, increased plant stand and early and better germination; or any other advantages familiar to a person skilled in the art.

As used herein, the term “locus” includes not only areas, environment, or habitat where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “ha” refers to hectare.

It will be understood that when an element is referred to as being “on” another element, it can be directly in contact with the other element or intervening elements may be present therebetween. In contrast, when an element is referred to as being “directly on” another element, there are no intervening elements present.

As used herein, said spirotetramat is cis-spirotetramat or in the form of its cis/trans isomeric mixture.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

It has surprisingly been found that the combination of keto-enol insecticide and compounds having the formula (I) can provide a superior efficacy than when the keto-enol insecticide is applied not in combination with the compound of formula (I). It was also surprising that the combination of the keto-enol insecticide and compounds having the formula (I) can provide quick pest kill.

The present invention provides a combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

In some embodiments, R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50. In some embodiments, R1 is linear or branched, saturated or unsaturated acyl radical having 18 carbon atoms, m is an integer equal to 2, n is an integer equal to 3, x is an integer of from 1 to 50 and y is an integer of from 0 to 50. In some embodiments, R1 is linear, saturated or unsaturated acyl radical having 18 carbon atoms, m is an integer equal to 2, n is an integer equal to 3, x is an integer of from 1 to 50 and y is an integer of from 0 to 50. In some embodiments, R1 is oleate, m is an integer equal to 2, n is an integer equal to 3, x is an integer of from 1 to 50 and y is equal to 0.

In some embodiments, the keto-enol insecticide is selected from spirotetramat, spiromesifen, spirodiclofen, spiropidion and any combination thereof. In one embodiment, the keto-enol insecticide is spirotetramat.

In some embodiments, the combination is synergistic.

In some embodiments, the amount of the compound of formula (I) improves the insecticidal efficacy of the amount of the keto-enol insecticide compared to when the same amount of the keto-enol insecticide is applied not in combination with the amount of compound of formula (I).

In some embodiments, the amount of the compound of formula (I) improves the insecticidal efficacy of the amount of spirotetramat compared to when the same amount of spirotetramat is applied not in combination with the amount of compound of formula (I).

In some embodiments, insecticidal efficacy is increased by at least 5%, 10%, 20%, or 30% compared to when the same amount of the keto-enol insecticide is applied alone. In some embodiments, insecticidal efficacy is increased by at least 50%, 100%, 200% or 300% compared to when the same amount of the keto-enol insecticide is applied alone.

In some embodiments, insecticidal efficacy is measured in a treated area of the plant. In some embodiments, insecticidal efficacy is measured in an untreated area of the plant. In some embodiments, insecticidal efficacy is increased in a treated area of the plant. In some embodiments, insecticidal efficacy is increased in an untreated area of the plant.

In some embodiments, insecticidal efficacy is measured not more than 7 days after treatment/application.

In some embodiments, a substantially similar level of insecticidal efficacy is achieved by using a lesser amount of the compound of formula (I) and/or the keto-enol insecticide.

In some embodiments, the amount of keto-enol insecticide in the combination is less than the insecticidally effective amount of keto-enol insecticide when keto-enol insecticide is used alone. In some embodiments, the amount of the keto-enol insecticide is less than its insecticidally effective amount. In some embodiments, the amount of the compound of formula (I) in the combination is less than the insecticidally effective amount of the compound of formula (I) when the compound of formula (I) is used alone.

In some embodiments, the amount of the compound of formula (I) is effective to increase sensitivity of the insect to the amount of the keto-enol insecticide compared to the sensitivity of the insect to the amount of the keto-enol insecticide when it applied not in combination with the amount of the compound of formula (I).

In some embodiments, the amount of the compound of formula (I) is effective to increase the penetration of the amount of the keto-enol insecticide compared to the penetration of the amount of the keto-enol insecticide when it is applied not in combination with the amount of the compound of formula (I).

In some embodiments, the amount of the compound of formula (I) is effective to increase the penetration into plant parts of the amount of the keto-enol insecticide compared to the penetration of the amount of the keto-enol insecticide when it is applied not in combination with the amount of the compound of formula (I).

Increasing penetration of the amount of the keto-enol insecticide into the plant. The keto-enol insecticide may penetrate the plant by penetrating into leaves (including penetrating leaf cuticle) and/or roots. In some embodiments, the combination of the amount of the keto-enol insecticide and the amount of the compound of formula (I) increases penetration of the amount of the keto-enol insecticide into the plant. In some embodiments, the combination of the amount of the keto-enol insecticide and the amount of the compound of formula (I) increases penetration of the amount of the keto-enol insecticide into the plant leaf. In some embodiments, the combination of the amount of the keto-enol insecticide and the amount of the compound of formula (I) increases penetration of the keto-enol insecticide into the plant root.

In some embodiments, the amount of the compound of formula (I) is effective to increase the bioavailability of the amount of the keto-enol insecticide compared to the bioavailability of the amount of the keto-enol insecticide when it is applied not in combination with the amount of the compound of formula (I).

Increasing bioavailability also includes increased translocation of the amount of the keto-enol insecticide once inside the plant, including leaves. In some embodiments, the combination of the amount of the keto-enol insecticide and the amount of the compound of formula (I) increases translocation of the amount of the keto-enol insecticide after penetration into the plant.

In some embodiments, the combination is more effective in treating the plant or the locus against animal pests than when the keto-enol insecticide is applied alone at the same amount.

In some embodiments, the combination is more effective in treating the plant or locus against animal pest than when the insecticide and the compound of formula (I) in the same amount is applied alone.

In some embodiments, the keto-enol insecticide as part of the combination is more effective in treating the plant or locus against animal pest than when applied at the same amount alone. Increased effectiveness may be due to increased bioavailability and/or uptake by the plant.

In some embodiments, the amount of the keto-enol insecticide and the amount of the compound of formula (I) are more effective for treat a plant or locus against animal pest than when the amount of the compound of formula (I) and the amount of a keto-enol insecticide are applied alone. In some embodiments, the combination comprises one or more keto-enol insecticide (s) and the combination of the compound of formula (I) and at least one of the keto-enol insecticides applied is more effective in treating the plant or soil against animal pest than when the keto-enol insecticide and the compound of formula (I) at the same amount is applied alone.

In some embodiments, treating the plant or locus against animal pest comprises protecting the plant or locus from animal pest attack.

In some embodiments, treating the plant or locus against animal pest comprises protecting the plant or locus from animal pest infestation.

In some embodiments, treating the plant or locus against animal pest comprises preventing animal pest infestation of the plant or locus.

In some embodiments, treating the plant or locus against animal pest comprises controlling animal pest infestation affecting the plant or locus.

In some embodiments, the combination reduces the amount of time needed to achieve a level of animal pest control than when the amount of the keto-enol insecticide is applied alone.

Non limiting example for reduction is, if each the keto-enol insecticide and the compound of formula (I) is applied alone achieves 50% control of animal pest infestation 10 days after application, the mixture or composition disclosed herein achieves 50% control of animal pest infestation 3 days after application where each the keto-enol insecticide and the compound of formula (I) is applied at the same amount.

In some embodiments, the amount of time needed to achieve an animal pest control is reduced by at least 1 day, 2 days, 3 days, 4 day, 5 days, 6 days, or 7 days.

In some embodiments, the weight ratio between the total amount of the keto-enol insecticide to the total amount of the compound having the formula (I) is of about 90:1 to about 9:1.

In some embodiments, the weight ratio between the total amount of the keto-enol insecticide to the total amount of the compound having the formula (I) is of about 12:1.

In some embodiments, the mixture or composition disclosed herein is for use in reducing the amount of time needed to achieve a level of animal pest control.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The combinations of the invention can be used to combat and control infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortoicetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodochrous spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Oligonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Orycaephilus spp., Otiorhynchus spp., Phlyctinus spp., Popillia spp., Psylliodes spp., Rhizopertha spp., Scarabaeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments the combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 is for increasing the penetration of keto-enol insecticide to the plant.

Increasing the penetration to the plant is the ability of the keto-enol insecticide to penetrate and/or absorbed within the plant parts such as roots, stems, leaves, flowers, seed and etc.. In some embodiments the plant part is the leaves.

In some embodiments, the combination is a mixture.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50.

In some embodiments, the combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50.

In some embodiments, the combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50.

In some embodiments, the combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1.

In some embodiments, the combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1.

In some embodiments, the combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1.

In some embodiments, the combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 90:1 to about 9:1.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1.

In some embodiments, the combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1.

In some embodiments, the combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1.

In some embodiments, the combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1.

In some embodiments, the combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 12:1.

In certain aspects, the invention provides a method for increasing the penetration of a keto-enol insecticide to plant parts wherein the method comprises applying a combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant locus.

In some embodiments, the amount of the compound of formula (I) is effective to increase the penetration of the amount of the keto-enol insecticide to a plant compared to the penetration of the amount of the keto-enol insecticide when it is applied not in combination with the amount of the compound of formula (I).

Increasing penetration of the amount of the keto-enol insecticide into the plant. The keto-enol insecticide may penetrate the plant by penetrating into leaves (including penetrating leaf cuticle) and/or roots. In some embodiments, the combination of the amount of the keto-enol insecticide and the amount of the compound of formula (I) increases penetration of the amount of the keto-enol insecticide into the plant. In some embodiments, the combination of the amount of the keto-enol insecticide and the amount of the compound of formula (I) increases penetration of the amount of the keto-enol insecticide into the plant leaf. In some embodiments, the combination of the amount of the keto-enol insecticide and the amount of the compound of formula (I) increases penetration of the keto-enol insecticide into the plant root.

In some embodiments, the amount of the compound of formula (I) is effective to increase the bioavailability of the amount of the keto-enol insecticide compared to the bioavailability of the amount of the keto-enol insecticide when it is applied not in combination with the amount of the compound of formula (I).

Increasing bioavailability also includes increased translocation of the amount of the keto-enol insecticide once inside the plant, including leaves. In some embodiments, the combination of the amount of the keto-enol insecticide and the amount of the compound of formula (I) increases translocation of the amount of the keto-enol insecticide after penetration into the plant.

In some embodiments, the combination is more effective in treating the plant or the locus against animal pests than when the keto-enol insecticide is applied alone at the same amount.

In some embodiments, the combination is more effective in treating the plant or locus against animal pest than when the insecticide and the compound of formula (I) in the same amount is applied alone.

In some embodiments, the keto-enol insecticide as part of the combination is more effective in treating the plant or locus against animal pest than when applied at the same amount alone. Increased effectiveness may be due to increased bioavailability and/or uptake by the plant.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant locus.

In some embodiments, the method is for increasing the penetration of a keto-enol insecticide to a plant wherein the method comprises applying a combination comprising an amount of the keto-enol insecticide and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to a plant locus.

In some embodiments, the method for increasing the penetration of a keto-enol insecticide to a plant comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to a plant locus.

In some embodiments, the method is for increasing the penetration of a keto-enol insecticide to a plant wherein the method comprises applying a combination comprising an amount of the keto-enol insecticide and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 90:1 to about 9:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant locus.

In some embodiments, the method is for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 12:1 to a plant locus.

In some embodiments, the method for increasing the penetration of spirotetramat to a plant locus enables to reduce the amount of time needed to achieve a level of animal pest control than when the amount of spirotetramat is applied alone.

In some embodiments, the method for increasing the penetration of spirotetramat to a plant locus enables to reduce the amount of time needed to achieve a level of animal pest control than when the amount of spirotetramat is applied without the compound of formula (I).

Non limiting example for reduction is, if each spirotetramat and the compound of formula (I) is applied alone achieves 50% control of animal pest infestation 10 days after application, the mixture, combination or composition disclosed herein achieves 50% control of animal pest infestation 3 days after application where each spirotetramat and the compound of formula (I) are applied at the same amount.

In some embodiments, the amount of time needed to achieve an animal pest control is reduced by at least 1 day, 2 days, 3 days, 4 day, 5 days, 6 days, or 7 days.

In some embodiments, the weight ratio between the total amount of spirotetramat to the total amount of the compound having the formula (I) is of about 90:1 to about 9:1.

In some embodiments, the weight ratio between the total amount of spirotetramat to the total amount of the compound having the formula (I) is of about 12:1.

In some embodiments, the mixture, combination or composition disclosed herein is for use in reducing the amount of time needed to achieve a level of animal pest control.

In some embodiments, the plant is selected from pomaceous fruit, stone fruit, soft fruit, apples, pears, avocado, plums, peaches, almonds, cherries, berries, strawberries, raspberries, blackberries, citrus fruit, oranges, lemons, grapefruit, tangerines, cucurbits, pumpkins, cucumbers, melons, lettuce, cabbages, carrots, tomatoes, potatoes, peppers, chilli, okra, eggplants, beans, peas, soya, oilseed rape, olives, sunflowers, ground nuts, cotton, nuts, coffee, grapevines, ornamentals or lauraceae.

In some embodiments the invention provides a method for increasing the penetration of a keto-enol insecticide to a plant wherein the method comprises applying a combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant.

Increasing the penetration to the plant is the ability of the keto-enol insecticide to penetrate and/or absorbed within the plant and/or plant parts such as roots, stems, leaves, flowers, seed and etc.. In some embodiments the plant part is the leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 90:1 to about 9:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 12:1 to a plant.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 90:1 to about 9:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 90:1 to about 9:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50; and the weight ratio between the total amount of spirotetramat to the total amount of the compound having the formula (I) is of about 12:1 to a plant leaves.

In some embodiments the invention provides a method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0; and the weight ratio between the total amount of spirotetramat to the total amount of the compound having the formula (I) is of about 12:1 to a plant leaves.

In some embodiments, the plant is selected from pomaceous fruit, stone fruit, soft fruit, apples, pears, avocado, plums, peaches, almonds, cherries, berries, strawberries, raspberries, blackberries, citrus fruit, oranges, lemons, grapefruit, tangerines, cucurbits, pumpkins, cucumbers, melons, lettuce, cabbages, carrots, tomatoes, potatoes, peppers, chilli, okra, eggplants, beans, peas, soya, oilseed rape, olives, sunflowers, ground nuts, cotton, nuts, coffee, grapevines, ornamentals or lauraceae.

The present invention also provides a composition comprising an amount of a keto-enol insecticide, an amount of a compound having the formula (I): R1-O—(CmH2mO)x-(CnH2nO)y-H wherein R1 is linear or branched, saturated or unsaturated alkyl radical having from 7 to 20 carbon atoms; or R1 is linear or branched, saturated or unsaturated acyl radical having from 14 to 20 carbon atoms; or any combination thereof; m is an integer equal to 2, n is an integer equal to 3, x is an integer of from 1 to 50 and y is an integer of from 0 to 50 and at least one agriculturally acceptable carrier.

In some embodiments, the amount of keto-enol insecticide is of about 10% to of about 60% by weight, based on the total weight of the composition.

In some embodiments, the amount of the compound having the formula (I) is of about 0.5% to of about 5% by weight, based on the total weight of the composition.

In some embodiments, the amount of keto-enol insecticide is of about 10% to of about 60% by weight, based on the total weight of the composition and the amount of the compound having the formula (I) is of about 0.5% to of about 5% by weight, based on the total weight of the composition.

In some embodiments, the composition comprises at least one agriculturally acceptable additive selected from the group containing surfactants, solid diluents, liquid diluents, adjuvants and any combination thereof.

In some embodiments, the weight ratio between the total amount of the keto-enol insecticide to the total amount of the compound having the formula (I) is of about 90:1 to about 9:1.

In some embodiments, the weight ratio between the total amount of the keto-enol insecticide to the total amount of the compound having the formula (I) is of about 12:1.

In some embodiments, the keto-enol insecticide is selected from spirotetramat, spiromesifen, spirodiclofen, spiropidion and any combination thereof. In one embodiment, the keto-enol insecticide is spirotetramat.

In some embodiments, R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50. In some embodiments, R1 is linear or branched, saturated or unsaturated acyl radical having 18 carbon atoms, m is an integer equal to 2, n is an integer equal to 3, x is an integer of from 1 to 50 and y is an integer of from 0 to 50. In some embodiments, R1 is linear, saturated or unsaturated acyl radical having 18 carbon atoms, m is an integer equal to 2, n is an integer equal to 3, x is an integer of from 1 to 50 and y is an integer of from 0 to 50. In some embodiments, R1 is oleate, m is an integer equal to 2, n is an integer equal to 3, x is an integer of from 1 to 50 and y is equal to 0.

In some embodiments, the composition comprising spirotetramat, a compound having the formula (I): R1-O—(CmH2mO)x-(CnH2nO)y-H wherein, R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is linear or branched, saturated or unsaturated acyl radical having 18 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is linear, saturated or unsaturated acyl radical having 18 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is oleate; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is oleate; m is an integer equal to 2, n is an integer equal to 3, x is an integer of from 1 to 50 and y is equal to 0 and at least one agriculturally acceptable carrier.

In some embodiments, the composition comprising spirotetramat, a compound having the formula (I): R1-O—(CmH2mO)x-(CnH2nO)y-H wherein, R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is linear or branched, saturated or unsaturated acyl radical having 18 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is linear, saturated or unsaturated acyl radical having 18 carbon atoms; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is oleate; m is an integer equal to 2, n is an integer equal to 3, x is an integer of from 1 to 50 and y is an integer of from 0 to 50 and at least one agriculturally acceptable carrier.

In some embodiments, the composition comprising spirotetramat, a compound having the formula (I): R1-O—(CmH2mO)x-(CnH2nO)y-H wherein, R1 is oleate; m is an integer equal to 2, n is an integer equal to 3, x is an integer of from 1 to 50 and y is equal to 0 and at least one agriculturally acceptable carrier.

In some embodiments, the amount of spirotetramat is of about 10% to of about 60% by weight, based on the total weight of the composition and the amount of the compound having the formula (I) is of about 0.5% to of about 5% by weight, based on the total weight of the composition.

In some embodiments, the weight ratio between the total amount of spirotetramat to the total amount of the compound having the formula (I) in the composition is of about 90:1 to about 9:1.

In some embodiments, the weight ratio between the total amount of spirotetramat to the total amount of the compound having the formula (I) in the composition is of about 12:1.

The agriculturally acceptable carrier may be liquid or solid. Suitable carriers are described in detail below.

Suitable carriers and adjuvants may be solid or liquid and correspond to the substances ordinarily employed in formulation technology, such as, e.g. natural or regenerated mineral substances, solvents, dispersants, wetting fungicides, tackifiers, thickeners, binding fungicides or fertilizers. Such carriers are for example described in WO 96/22690.

Examples of suitable liquid carriers potentially useful in the present compositions include but are not limited to water; aromatic hydrocarbons such as alkylbenzenes and alkylnaphthalenes; alcohols such as cyclohexanol, and decanol; ethylene glycol; polypropylene glycol; dipropropylene glycol; N,N-dimethylformamide; dimethylsulfoxide; dimethylacetamide; N-alkylpyrrolidones such as N-methyl-2-pyrrolidone; paraffins; various oils such as olive, castor, linseed, tung, sesame, corn, peanut, cotton-seed, soybean, rape-seed, or coconut oil; fatty acid esters; ketones such as cyclohexanone, 2-heptanone, isophorone, and 4-hydroxy-4-methyl-2-pentanone; and the like.

Examples of suitable solid carriers potentially useful in the present compositions include but are not limited to mineral earths such as silica gels, silicates, talc, kaolin, sericite, attaclay, limestone, bentonite, lime, chalk, bole, mirabilite, loess, clay, dolomite, zeolite, diatomaceous earth, calcium carbonate, calcium sulfate, magnesium sulfate, magnesium oxide, sodium carbonate and bicarbonate, and sodium sulfate; ground synthetic materials; fertilizers such as ammonium sulfate, ammonium phosphate, ammonium nitrate, ureas, and products of vegetable origin, such as cereal meal, tree bark meal, wood meal, and nutshell meal; cellulose powders; and other solid carriers.

Other ingredients, such as wetting agents, anti-foaming, adhesives, neutralizers, thickeners, binders, sequestrates, fertilizers, biocides, stabilizers, buffers or anti-freeze agents, may also be added to the present compositions in order to increase the stability, density, and viscosity of the described compositions.

Aqueous use forms can be prepared from emulsion concentrates, suspensions, pastes, wettable powders or water-dispersible granules by adding water. To prepare emulsions, pastes or oil dispersions, the components of the compositions either as such or dissolved in an oil or solvent, can be homogenized in water by means of a wetting agent, tackifier, dispersant or emulsifier.

Alternatively, it is also possible to prepare concentrates comprising active component, wetting agent, tackifier, dispersant or emulsifier and, if desired, a solvent or oil, which are suitable for dilution with water.

Particularly compositions to be applied in spraying forms such as water dispersible concentrates or wettable powders may contain surfactants such as wetting and dispersing insecticides, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The composition according to the invention is generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents. The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The formulation adjuvants that are suitable for the preparation of the formulations according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, /V,/V-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, V-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting fungicides or suspending fungicides or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters.

Further adjuvants that can be used in pesticidal formulations include crystallisation inhibitors, viscosity modifiers, suspending fungicides, dyes, anti-oxidants, foaming fungicides, light absorbers, mixing auxiliaries, antifoams, complexing fungicides, neutralising or pH-modifying substances and buffers, corrosion inhibitors, fragrances, wetting fungicides, take-up enhancers, micronutrients, plasticizers, glidants, lubricants, dispersants, thickeners, antifreezes, microbicides, and liquid and solid fertilizers.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The compositions of the invention can be used to combat and control infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortoicetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodochrous spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Oligonychus pratensis, Ornithodorus spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Oryzaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.15 L/ha to about 1.0 L/ha.

In some embodiments, the compositions of the present invention disclosed herein are for the use for controlling and/or preventing animal pests.

The present invention further provides a method of treating a plant or a locus against animal pest infestation comprising applying a combination of an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of the keto-enol insecticide is applied alone and/or
(ii) the amount of the compound having the formula (I) improves the insecticidal efficacy of the amount of the keto-enol insecticide compared to when the same amount of the keto-enol insecticide is applied not in combination with the amount of the compound having the formula (I).

In some embodiments, the method reduces the amount of time needed to achieve a level of animal pest control than when the amount of the keto-enol insecticide is applied alone.

In some embodiments, the method reduces the amount of time needed to achieve a level of animal pest control than when the amount of spirotetramat is applied alone.

In some embodiments, the amount of time needed to achieve a level of animal pest control is less than 7 days post application.

In some embodiments, the amount of time needed to achieve a level of animal pest control is between 3 to 7 days post application.

In some embodiments, the weight ratio between the total amount of the keto-enol insecticide to the total amount of the compound having the formula (I) is of about 90:1 to about 9:1.

In some embodiments, the weight ratio between the total amount of spirotetramat to the total amount of the compound having the formula (I) is of about 90:1 to about 9:1.

In some embodiments, the weight ratio between the total amount of the keto-enol insecticide to the total amount of the compound having the formula (I) is of about 12:1.

In some embodiments, the weight ratio between the total amount of spirotetramat to the total amount of the compound having the formula (I) is of about 12:1.

In some embodiments, R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50. In some embodiments, R1 is linear or branched, saturated or unsaturated acyl radical having 18 carbon atoms, m is an integer equal to 2, n is an integer equal to 3, x is an integer of from 1 to 50 and y is an integer of from 0 to 50. In some embodiments, R1 is linear, saturated or unsaturated acyl radical having 18 carbon atoms, m is an integer equal to 2, n is an integer equal to 3, x is an integer of from 1 to 50 and y is an integer of from 0 to 50. In some embodiments, R1 is oleate, m is an integer equal to 2, n is an integer equal to 3, x is an integer of from 1 to 50 and y is equal to 0.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I).

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I).

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I).

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I).

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I).

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I).

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 90:1 to about 9:1 In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 90:1 to about 9:1 In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 90:1 to about 9:1 In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 90:1 to about 9:1

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of the spirotetramat is applied not in combination with the amount of the compound having the formula (I) and
(iii) the amount of time needed to achieve a level of animal pest control is less than 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of the spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of the spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is less than 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of the spirotetramat is applied not in combination with the amount of the compound having the formula (I) and
(iii) the amount of time needed to achieve a level of animal pest control is between 3 to 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of the spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 90:1 to about 9:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of the spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 12:1.

In some embodiments, the method of treating a plant or a locus against animal pest infestation comprising applying a combination of an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 to the plant or locus, wherein:
(i) the method is more effective against animal pest infestation than when the amount of spirotetramat is applied alone and/or
(ii) the amount of the compound having the formula (I) improves the insecticidal efficacy of the amount of spirotetramat compared to when the same amount of spirotetramat is applied not in combination with the amount of the compound having the formula (I) and
(iii) the amount of time needed to achieve a level of animal pest control is between 3 to 7 days post application and
(iv) the weight ratio between the total amount of spirotetramat to the total amount of the compound having the formula (I) is of about 12:1.

In some embodiments, the keto-enol insecticide and the compound having the formula (I) are applied together, separately, simultaneously, contemporaneously, or successively.

In some embodiments, the keto-enol insecticide and the compound having the formula (I) are applied together.

In some embodiments, the keto-enol insecticide and the compound having the formula (I) are applied separately.

In some embodiments, the keto-enol insecticide and the compound having the formula (I) are applied simultaneously.

In some embodiments, the keto-enol insecticide and the compound having the formula (I) are applied contemporaneously.

In some embodiments, the keto-enol insecticide and the compound having the formula (I) are applied successively.

In some embodiments, the keto-enol insecticide is selected from spirotetramat, spiromesifen, spirodiclofen, spiropidion and any combination thereof. In one embodiment, the keto-enol insecticide is spirotetramat.

In some embodiments, the keto-enol insecticide and the compound having the formula (I) are applied as foliar application.

In some embodiments, the keto-enol insecticide is applied at a rate from 0.15 l/ha to 1.0 l/ha.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The methods of the invention are for combatting and controlling infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodochrous spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Oligonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Oryzaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

The present invention further provides a method for controlling animal pest comprising contacting the animal pest or its environment with an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

In some embodiments, the method reduces the amount of time needed to achieve a level of animal pest control than when the amount of the keto-enol insecticide is applied alone.

In some embodiments, the method reduces the amount of time needed to achieve a level of animal pest control than when the amount of the keto-enol insecticide is applied without compound of formula (I).

In some embodiments, the amount of time needed to achieve a level of animal pest control is less than 7 days post application.

In some embodiments, the amount of time needed to achieve a level of animal pest control is between 3 to 7 days post application.

In some embodiments, the weight ratio between the total amount of the keto-enol insecticide to the total amount of the compound having the formula (I) is of about 90:1 to about 9:1.

In some embodiments, the weight ratio between the total amount of the keto-enol insecticide to the total amount of the compound having the formula (I) is of about 12:1.

In some embodiments, R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50.

In some embodiments, R1 is linear or branched, saturated or unsaturated acyl radical having 18 carbon atoms, m is an integer equal to 2, n is an integer equal to 3, x is an integer of from 1 to 50 and y is an integer of from 0 to 50.

In some embodiments, R1 is linear, saturated, or unsaturated acyl radical having 18 carbon atoms, m is an integer equal to 2, n is an integer equal to 3, x is an integer of from 1 to 50 and y is an integer of from 0 to 50.

In some embodiments, R1 is oleate, m is an integer equal to 2, n is an integer equal to 3, x is an integer of from 1 to 50 and y is an integer of from 0 to 50.

In some embodiments, R1 is oleate, m is an integer equal to 2, n is an integer equal to 3, x is an integer of from 1 to 50 and y is equal to 0.

In some embodiments, the keto-enol insecticide and the compound having the formula (I) are applied together, separately, simultaneously, contemporaneously, or successively.

In some embodiments, the keto-enol insecticide and the compound having the formula (I) are applied together.

In some embodiments, the keto-enol insecticide and the compound having the formula (I) are applied separately.

In some embodiments, the keto-enol insecticide and the compound having the formula (I) are applied simultaneously.

In some embodiments, the keto-enol insecticide and the compound having the formula (I) are applied contemporaneously.

In some embodiments, the keto-enol insecticide and the compound having the formula (I) are applied successively.

In some embodiments, the keto-enol insecticide is selected from spirotetramat, spiromesifen, spirodiclofen, spiropidion and any combination thereof. In one embodiment, the keto-enol insecticide is spirotetramat.

In some embodiments, the keto-enol insecticide and the compound having the formula (I) are applied as foliar application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 90:1 to about 9:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 90:1 to about 9:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 90:1 to about 9:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 90:1 to about 9:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 90:1 to about 9:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 and wherein the weight ratio between the total amount of spirotetramat to the total amount of the compound having the formula (I) is of about 90:1 to about 9:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 12:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 12:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 12:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 12:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 and wherein the weight ratio between the total amount of spirotetramat to the total amount of the compound having the formula (I) is of about 12:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 and wherein the weight ratio between the total amount of spirotetramat to the total amount of the compound having the formula (I) is of about 12:1.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 wherein, the amount of time needed to achieve a level of animal pest control is less than 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 wherein, the amount of time needed to achieve a level of animal pest control is less than 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 wherein the amount of time needed to achieve a level of animal pest control is between 3 to 7 days post application.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 wherein the amount of time needed to achieve a level of animal pest control is between 3 to 7 days post application.

In some embodiments, spirotetramat and the compound having the formula (I) are applied together, separately, simultaneously, contemporaneously, or successively.

In some embodiments, spirotetramat and the compound having the formula (I) are applied together.

In some embodiments, spirotetramat and the compound having the formula (I) are applied separately.

In some embodiments, spirotetramat and the compound having the formula (I) are applied simultaneously.

In some embodiments, spirotetramat and the compound having the formula (I) are applied contemporaneously.

In some embodiments, spirotetramat and the compound having the formula (I) are applied successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 wherein, the amount of time needed to achieve a level of animal pest control is less than 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 wherein, the amount of time needed to achieve a level of animal pest control is less than 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 wherein, the amount of time needed to achieve a level of animal pest control is less than 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having from 16 to 18 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear or branched, saturated or unsaturated acyl radical having 18 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is linear, saturated or unsaturated acyl radical having 18 carbon atoms; m is an integer equal to 2, n is an integer equal to 3, x is an integer of from 1 to 50 and y is an integer of from 0 to 50 wherein the amount of time needed to achieve a level of animal pest control is between 3 to 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is an integer of from 0 to 50 wherein the amount of time needed to achieve a level of animal pest control is between 3 to 7 days post application and wherein spirotetramat and the compound having the formula (I) are applied together, separately, simultaneously, contemporaneously, or successively.

In some embodiments, the method for controlling animal pest comprising contacting the animal pest or its environment with an amount of spirotetramat and an amount of a compound having the formula (I): R1-O—(CmH2mO)x-(CnH2nO)y-H wherein R1 is oleate; m is an integer equal to 2, n is an integer equal to 3, x is an integer of from 1 to 50 and y is equal to 0 wherein the amount of time needed to achieve a level of animal pest control is between 3 to 7 days post application and wherein spirotetramat and the compound having the formula (I) are applied together, separately, simultaneously, contemporaneously, or successively.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The methods of the invention are for combatting and controlling infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodochrous spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Oligonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.15 L/ha to about 1.0 L/ha.

The present invention further provides a method for controlling animal pests comprising allowing an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to act on pests and/or their habitat.

In some embodiments, the method reduces the amount of time needed to achieve a level of animal pest control than when the amount of the keto-enol insecticide is applied alone.

In some embodiments, the amount of time needed to achieve a level of animal pest control is less than 7 days post application.

In some embodiments, the amount of time needed to achieve a level of animal pest control is between 3 to 7 days post application.

In some embodiments, the weight ratio between the total amount of the keto-enol insecticide to the total amount of the compound having the formula (I) is of about 90:1 to about 9:1.

In some embodiments, the weight ratio between the total amount of the keto-enol insecticide to the total amount of the compound having the formula (I) is of about 12:1.

In some embodiments, R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50.

In some embodiments, R1 is linear or branched, saturated or unsaturated acyl radical having 18 carbon atoms, m is an integer equal to 2, n is an integer equal to 3, x is an integer of from 1 to 50 and y is an integer of from 0 to 50.

In some embodiments, R1 is linear, saturated, or unsaturated acyl radical having 18 carbon atoms, m is an integer equal to 2, n is an integer equal to 3, x is an integer of from 1 to 50 and y is an integer of from 0 to 50.

In some embodiments, R1 is oleate, m is an integer equal to 2, n is an integer equal to 3, x is an integer of from 1 to 50 and y is equal to 0.

In some embodiments, the keto-enol insecticide and the compound having the formula (I) are applied together, separately, simultaneously, contemporaneously, or successively.

In some embodiments, the keto-enol insecticide and the compound having the formula (I) are applied together.

In some embodiments, the keto-enol insecticide and the compound having the formula (I) are applied separately.

In some embodiments, the keto-enol insecticide and the compound having the formula (I) are applied simultaneously.

In some embodiments, the keto-enol insecticide and the compound having the formula (I) are applied contemporaneously.

In some embodiments, the keto-enol insecticide and the compound having the formula (I) are applied successively.

In some embodiments, the keto-enol insecticide is selected from spirotetramat, spiromesifen, spirodiclofen, spiropidion and any combination thereof. In one embodiment, the keto-enol insecticide is spirotetramat.

In some embodiments, the keto-enol insecticide and the compound having the formula (I) are applied as foliar application.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The methods of the invention are for combatting and controlling infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodochrous spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Oligonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.15 L/ha to about 1.0 L/ha.

The present invention further provides a method of reducing the amount of time needed to achieve a level of animal pest control from an application of an amount of keto-enol insecticide to a plant or locus comprising applying a combination of an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and an amount of keto-enol insecticide to the plant or locus.

In some embodiments, the amount of time needed to achieve a level of animal pest control is less than 7 days post application.

In some embodiments, the amount of time needed to achieve a level of animal pest control is between 3 to 7 days post application.

In some embodiments, the weight ratio between the total amount of the keto-enol insecticide to the total amount of the compound having the formula (I) is of about 90:1 to about 9:1.

In some embodiments, the weight ratio between the total amount of the keto-enol insecticide to the total amount of the compound having the formula (I) is of about 12:1.

In some embodiments, R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50.

In some embodiments, R1 is linear or branched, saturated or unsaturated acyl radical having 18 carbon atoms, m is an integer equal to 2, n is an integer equal to 3, x is an integer of from 1 to 50 and y is an integer of from 0 to 50.

In some embodiments, R1 is linear, saturated, or unsaturated acyl radical having 18 carbon atoms, m is an integer equal to 2, n is an integer equal to 3, x is an integer of from 1 to 50 and y is an integer of from 0 to 50.

In some embodiments, R1 is oleate, m is an integer equal to 2, n is an integer equal to 3, x is an integer of from 1 to 50 and y is equal to 0.

In some embodiments, the keto-enol insecticide and the compound having the formula (I) are applied together, separately, simultaneously, contemporaneously, or successively.

In some embodiments, the keto-enol insecticide and the compound having the formula (I) are applied together.

In some embodiments, the keto-enol insecticide and the compound having the formula (I) are applied separately.

In some embodiments, the keto-enol insecticide and the compound having the formula (I) are applied simultaneously.

In some embodiments, the keto-enol insecticide and the compound having the formula (I) are applied contemporaneously.

In some embodiments, the keto-enol insecticide and the compound having the formula (I) are applied successively.

In some embodiments, the keto-enol insecticide is selected from spirotetramat, spiromesifen, spirodiclofen, spiropidion and any combination thereof. In one embodiment, the keto-enol insecticide is spirotetramat.

In some embodiments, the keto-enol insecticide and the compound having the formula (I) are applied as foliar application.

In some embodiments, the locus where the animal pests to be controlled is a crop field.

No limiting examples of suitable crops include cereals, such as wheat, barley, rye, oats, rice, maize, sorghum; beet, such as sugar, fodder beet; fruit, for example pomaceous fruit, stone fruit or soft fruit, such as apples, pears, avocado, plums, peaches, almonds, cherries, berries, for example strawberries, raspberries, blackberries; cinnamonium, camphor citrus fruit, such as oranges, lemons, grapefruit, tangerines; cucurbits, such as pumpkins, cucumbers, melons, vegetables, such as spinach, lettuce, asparagus, cabbages, carrots, onions, tomatoes, potatoes or peppers, chilli, okra, eggplants; leguminous crops, such as beans, lentils, peas, soya; oil crops, such as oilseed rape, mustard, poppies, olives, sunflowers, coconut, castor, cocoa, ground nuts; fibre plants, such as cotton, flax, hemp, jute; and also tobacco, nuts, coffee, sugarcane, tea, grapevines, hops, the plantain family, latex plants ornamentals and lauraceae.

The methods of the invention are for combatting and controlling infestations of animal pests such as Lepidoptera, Diptera, Hemiptera, Thysanoptera, Coleoptera, Hymenoptera and also other invertebrate pests, for example, acarine, nematode and mollusc pests. Insects, acarines, nematodes and molluscs are hereinafter collectively referred to as pests. The animal pests which may be combated and controlled by the use of the invention compounds include those animal pests associated with agriculture (which term includes the growing of crops for food and fibre products), horticulture and animal husbandry, forestry and the storage of products of vegetable origin (such as fruit, grain and timber). Non limiting examples of pest species which may be controlled by the compositions of the invention include Myzus persicae (aphid), Aphis gossypii (aphid), Aphis fabae (aphid), Lygus spp. (capsids), Dysdercus spp. (capsids), Nilaparvata lugens (planthopper), Nephotettix cincticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Pseudococcus SPP. (mealybugs) Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Liriomyza spp. (leafminer), Meloidogyne spp. (root knot nematodes), Globodera spp. and Heterodera spp. (cyst nematodes), Pratylenchus spp. (lesion nematodes), Rhodochrous spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug). From the order Acarina, for example, Acarus siro, Aceria sheldoni, Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus carpini, Eriophyes spp., Hyalomma spp., Ixodes spp., Oligonychus pratensis, Ornithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; From the order Coleoptera, for example, Agriotes spp., Anthonomus spp., Atomaria linearis, Chaetocnema tibialis, Cosmopolites spp., Curculio spp., Dermestes spp., Diabrotica spp., Epilachna spp., Eremnus spp., Leptinotarsa decemLineata, Lissorhoptrus spp., Melolontha spp., Orycaephilus spp., Otiorhynchus spp., Phlyctinus spp., Popillia spp., Psylliodes spp., Rhizopertha spp., Scarabeidae, Sitophilus spp., Sitotroga spp., Tenebrio spp., Tribolium spp. and Trogoderma spp.; From the order Diptera, for example, Aedes spp., Antherigona soccata, Bibio hortulanus, Calliphora erythrocephala, Ceratitis spp., Chrysomyia spp., Culex spp., Cuterebra spp., Dacus spp., Drosophila melanogaster, Fannia spp., Gastrophilus spp., Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis pomonella, Sciara spp., Stomoxys spp., Tabanus spp., Tannia spp. and Tipula spp.; From the order Heteroptera, for example, Cimex spp., Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; From the order Homoptera, for example Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium corni, Lepidosaphes spp., Macrosiphus spp., Myzus spp., Nephotettix spp., Nilaparvata spp., Parlatoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; From the order Hymenoptera, for example, Acromyrmex, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; From the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, ChNo spp., Choristoneura spp., Clysia ambiguella, Cnaphalocrocis spp., Cnephasia spp., Cochylis spp., Coleophora spp., Crocidolomia binotalis, Cryptophlebia leucotreta, Cydia spp., Diatraea spp., Diparopsis castanea, Earias spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiela, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Thysanoptera, for example, Frankliniella spp., Hercinothrips spp., Scirtothrips aurantii, Taeniothrips spp., Thrips palmi and Thrips tabaci; and from the order Thysanura, for example, Lepisma saccharina.

In some embodiments, the composition is applied in an amount from about 0.15 L/ha to about 1.0 L/ha.

The invention is illustrated by the following examples without limiting it thereby.

### EXAMPLES

### Example 1—Spirotetramat Formulation A

TABLE 1

| Materials | g/L |
|---|---|
| Spirotetramat | 480 |
| ATLOX 4913 (Acrylic copolymer solution) | 30 |
| Break Thru 233 (non-ionic trisiloxane surfactant) | 10 |
| Ethylan NS 500 LQ (non-ionic surfactant, polyalkoxylated butyl | 20 |
| ether) | |
| proxel GXL (1,2-Benzisothiazolin-3-one) | 0.10 |
| Silcolapse 432 (non-ionic, polydimethylsiloxanic oil based, | 5 |
| aqueous emulsion) | |
| Propylene Glycol | 50 |
| ISOPAR v (Mineral Oil 14-19) | 40 |
| EMCOL 4500 (Sodium dioctyl sulphosuccinate) | 20 |
| Alkamuls AP (PEG Ester/Ethoxylated Acid) | 40 |
| Xanthan Gum | 2 |
| water | Up to |
| | 1000 L |

### Preparation Procedure:

All the stages take place at room temperature about 23° C.±2° C.

### Stage 1—

1. Spirotetramat, ATLOX 4913, Break Thru 233, Ethylan NS 500 LQ, proxel GXL, Silcolapse 432 (half the amount), propylene glycol and water (100 g/L) were mixed.
2. The mixture was milled to get the desired particle size distribution LT 6 microns

### Stage 2—

1. ISOPAR v, EMCOL 4500 and Alkamuls AP were mixed until clear solution was obtained.
2. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 2—Spirotetramat Formulation B

TABLE 2

| Materials | g/L |
|---|---|
| Spirotetramat | 480 |
| ATLOX 4913 (Acrylic copolymer solution) | 30 |
| Break Thru 233 (non-ionic trisiloxane surfactant) | 10 |
| Ethylan NS 500 LQ (non-ionic surfactant, polyalkoxylated butyl | 20 |
| ether) | |
| proxel GXL (1,2-Benzisothiazolin-3-one) | 0.10 |
| Silcolapse 432 (non-ionic, polydimethylsiloxanic oil based, | 5 |
| aqueous emulsion) | |
| Propylene Glycol | 50 |
| ISOPAR v (Mineral Oil 14-19) | 40 |
| EMCOL 4500 (Sodium dioctyl sulphosuccinate) | 20 |
| Atplus 245 (Alcohols, C11-15-secondary, ethoxylated) | 40 |
| Xanthan Gum | 2 |
| water | Up to |
| | 1000 L |

### Preparation Procedure:

All the stages take place at room temperature about 23° C.±2° C.

### Stage 1—

3. Spirotetramat, ATLOX 4913, Break Thru 233, Ethylan NS 500 LQ, proxel GXL, Silcolapse 432 (half the amount), propylene glycol and water (100 g/L) were mixed.
4. The mixture was milled to get the desired Particle size distribution LT 6 microns

### Stage 2—

3. ISOPAR v, EMCOL 4500 and Atplus 245 were mixed until clear solution was obtained.
4. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 3—Spirotetramat Formulation C

TABLE 3

| Materials | g/L |
|---|---|
| Spirotetramat | 480 |
| ATLOX 4913 | 30 |
| Break Thru 233 (non-ionic trisiloxane surfactant) | 10 |
| Ethylan NS 500 LQ (non-ionic surfactant, polyalkoxylated butyl | 20 |
| ether) | |
| proxel GXL (1,2-Benzisothiazolin-3-one) | 0.10 |
| Silcolapse 432 (non-ionic, polydimethylsiloxanic oil based, | 5 |
| aqueous emulsion) | |
| Propylene Glycol | 50 |
| ISOPAR v (Mineral Oil 14-19) | 40 |
| EMCOL 4500 (Sodium dioctyl sulphosuccinate) | 20 |
| Genapol X50 (Iso-tridecyl alcohol polyglycol ether with 5 EO) | 40 |
| Xanthan Gum | 2 |
| water | Up to |
| | 1000 L |

### Preparation Procedure:

All the stages take place at room temperature about 23° C.±2° C.

### Stage 1—

5. Spirotetramat, ATLOX 4913, Break Thru 233, Ethylan NS 500 LQ, proxel GXL, Silcolapse 432 (half the amount), propylene glycol and water (100 g/L) were mixed.
6. The mixture was milled to get the desired particle size distribution LT 6 microns

### Stage 2—

5. ISOPAR v, EMCOL 4500 and Genapol X50 were mixed until clear solution was obtained.
6. Add oil phase to the milled mixture from stage 1.

### Stage 3—

1. The solution from stage 2 was added to the milled mixture from stage 1.
2. High Shear was applied.
3. Extra water (up to 1000 L), silcolapse 432 (half the Amount) and Xanthan Gum were added; if needed adjust with citric acid to get pH between 4-4.5.
4. The solution was mixed until homogenous suspension was obtained.

### Example 4—Control of Nymphs of Planococcus Spp.

### Objective:

Efficacy test of Movento 480 HL and formulations A-C containing spirotetramat to control Planococcus spp nymphs.

### Methods

The biological efficacy of formulations A-C of Spirotetramat 480 SC with doses of 0.20 L/ha on white mealybugs Planococcus spp. in grapevine cultivation, and comparing them with commercial formulation of Movento 480 SC at a dose of 0.20, in addition to a control without application.

Formulations A-C and the commercial product were applied via foliar application on Vitis vinifera plants by using backpack sprayer pressurized with CO₂ was used for the formulation application, providing a volume of 1,200 L/ha. The initial average infestation of the pest before spraying application was between 5-7 nymphs per treatment.

The trail had a completely randomized design.

The pest evaluation was conducted at 3, 7, 10 and 28 days after the application (DAA) on the nymphs stage by counting the alive mealybugs on the wood and on the clusters.

Table 4 represents the average results of Spirotetramat treatments in the number of nymphs of Planococcus spp. in the grape plants (5 plants per replica).

TABLE 4

| | 3 days post | | 7 days post | | 10 days post | | 28 days post | |
|---|---|---|---|---|---|---|---|---|
| | application | | application | | application | | application | |
| Name | Avg | group | Prom | grup | Prom | grup | Prom | grup |
| Control | 7.00 | a | 6.50 | a | 6.75 | a | 7.25 | a |
| Movento HL | 1.75 | a | 1.50 | a | 1.50 | a | 2.75 | b |
| 480SC | | | | | | | | |
| Formulation | 0.00 | b | 0.00 | b | 0.00 | b | 1.75 | b |
| A | | | | | | | | |
| Formulation | 3.50 | a | 3.50 | a | 3.50 | a | 2.50 | b |
| B | | | | | | | | |
| Formulation | 5.00 | a | 6.00 | a | 5.00 | a | 1.00 | b |
| C | | | | | | | | |

### Conclusions—

It is clearly shown that formulation A which comprises spirotetramat and the compound of formula (I) show better control and quick kill within 3 and 7 days after application.

### Example 5—Efficacy Trial for Controlling Myzus persicae with Spirotetramat Formulations

Objective: efficacy trial for controlling Myzus persicae with spirotetramat formulations. In the trial a comparison of the efficacy of the tested formulations was observed. The pest that was targeted was Myzus persicae which is a key pest in Pomegrant crop.
crop: Pomegranate
Location: Bloom
Season: Summer
Year: 2022

### Materials and Methods

Verity: Valley
Planting Date: 20 21
Planting estimate: 56 trees per dunam
The format of the trial, the number and size of the repetitions: random blocks, 4 repetitions for treatment, 3 trees per repetition.
Irrigation method: dripping.
Ground: Sand
Stage of growth during treatment: Pomegranate 1 year planting with young growths.
Sprayer: Back sprayer blower opening blower 4.
Spray volume: Full coverage, about 500 liters per hectare.
Application date: 6 Jun. 2022
Weather conditions: Temperature: 22° C.; Relative humidity: 79%; Wind: L.L.A.
Evaluation 0: Marking infected trees. Level of 50+aphids to branch.
Evaluation method: counting alive aphids on 4 branches per each repetition.
Evaluation dates: 9 Jun. 22, 14 Jun. 22,
   The treatments

TABLE 5
Details of the treatments in the experiment

| | Treatments | Ai (g/l) | Formulation |
|---|---|---|---|
| 1 | Movento 100 | Spirotetramat 100 g/l | (SC) |
| 2 | Formulation A | Spirotetramat 480 g/l | (SC) |

### Treatments:

TABLE 6
Details of the treatments in the trial

| Treatment | | concentration |
|---|---|---|
| No. | Treatments | % (dunam) |
| 1 | Movento 100 | 0.09 |
| 2 | Formulation A | 0.02 |
| 3 | UTC | — |

### Results

TABLE 7
Average number of alive aphids at 3, 8 days after application

| | | Number of | Number of |
|---|---|---|---|
| Treatment | | Aphids for | Aphids for |
| No. | Treatment | branch 3 DAA | branch 8 DAA |
| 1 | Movento ® | 27.9 AB | 0.13 B |
| | 100 | | |
| 2 | Formulation | 3.8 C | 0 B |
| | A | | |
| 3 | UTC | 47.5 A | 44.4 A |

*Treatments with different letters in the same column are statistically distinguished according to the Tukey kramer test at a significance levelα = 0.05

### Conclusions

It is clearly shown that formulation A possess fast acting activity which allows control of Aphids population only three days after application.

### Example 6—Analytical Evaluation of the Foliar Penetration for Spirotetramat Formulations

The purpose of the experiment was the quantitative evaluation of Spirotetramat uptake into bean leaves

The test materials were applied on model plants using the track sprayer at the recommended field rates (taken from the label) at designated spraying volume. The applied solutions were allowed to dry in the chemical hood and treated plants maintained in optimal growth conditions. The plants were sampled using the leaf disks method and the excised plant tissue then analysed by the validated HPLC method to measure the amounts of the active material absorbed by the leaf tissue.

Host plant: common red beans (Phaseolus vulgaris)

The plants were grown for 4-5 weeks prior to the experiment in 125 ml pots. One seed was planted in each pot, according to growth conditions below:

Sowing: the standard potting soil was sieved to remove the peat and coconut clumps and filled in disposable 7*7 cm plastic pots. The potting soil was slightly packed and sprayed with water until wetness. The seeds were placed in ˜1 cm deep holes made with a pencil, with the root axis pointing down. The seeds were covered with vermiculite or sieved soil to the pot brim. The pots were sprayed gently with the sprinkler until the soil was thoroughly wet but not soaked. Following the sowing the pots were placed in the 30 cm growth trays and irrigated from the bottom.

Irrigation: Bottom irrigation every day, excess water removed from the trays Temperature: 21±1° C. (day and night).

Light: 14/10 light/darkness photoperiod, fluorescent or LED overhead lights.

Spirotetramat solutions of formulation A and the commercial product Movento® 100 SC were prepared according to table 8 immediately before the application in deionized water.

To evaluate the penetration to the leaves, the solutions of formulation A (according to the invention) and the commercial product Movento® 100 SC were sprayed on plants using track sprayer at a spraying volume equivalent to the field application (200 L/Ha). the following steps were carried out:
1. Determination of the concentration of spirotetramat active that reached the leaf was assessed according to steps 3-4 of the below protocol and are summarized in table 10.
2. Determination of spirotetramat concentration penetrated to the leaf was assessed according to steps 1-4 of the below protocol and are summarized in table 11.

### Protocol:

1. Treatment Application:
   a. Uniform bean plants of the same age and growth stage as much as possible were selected for the study.
   b. the treatments were sprayed on the bean plants, allowed to dry for 0.5 hr in the chemical hood and then the treated plants were maintained in the growth room.
   c. Unsprayed plants (blank) and unwashed plants representing 100% of applied Spirotetramat) for both tested materials were maintained in the same growth conditions.
2. Washing procedure (wiping): following the designated incubation time, each of the treated leaves was detached from the plant and wiped according to the specified timepoints (see table 11) with wet wipes (wet wipes for personal hygiene) for 30 seconds. The wiped leaves were allowed to dry for 5 min on the bench facing upwards. The wiping effectively removed the unabsorbed material from the leaf surface and allowed to measure the concentration of spirotetramat absorbed by the leaf tissue.
3. Leaf sample preparation:
   a. Maximum possible number of identical leaf disks were incised from the treated leaves using 22 mm round leaf cutter and the number of leaf disks was recorded.
   b. Fresh leaf discs were cut into pieces with the surgical scissors and extracted in 50 mL conical centrifuge cubes with 15 ml of HPLC-grade acetonitrile.
   c. The sample containers were agitated for 2 hours on orbital flask shaker at room temp (˜22° C.), then stored in the refrigerator at 4° C. for analytical tests.
4. Analytical sample preparation: the acetonitrile extracts from each sample were filtered using 0.45 μm syringe filter and analyzed using validated HPLC method for spirotetramat determination—the samples tested by HPLC method used Xbridge waters phenyl 3 μm 150*4.6 mm with gradient of Acetonitrile, Methanol and phosphoric acid 0.1% as mobile phase.
5. The calculation performed as w/w % versus analytical standard.

TABLE 8
Spirotetramat solution preparations

| | | | | Al | | | Amount |
|---|---|---|---|---|---|---|---|
| | Al conc. | | Spray | concentration | Volume of | Active in | taken from |
| | in | Label field | application | in application | the tested | tested | concentrated |
| | product | rate | volume | solution | application | application | product |
| Material | [g/l] | [g Al/Ha] | [L/Ha] | [g/L] | [ml] | [mg] | [μL] |
| Movento ® | 100 | 96 | 200 | 0.48 | 200 | 96 | 960 |
| 100 SC | | | | | | | |
| (Bayer) | | | | | | | |
| Formulation | 480 | 96 | 200 | 0.48 | 200 | 96 | 200 |
| A | | | | | | | |

### HPLC Data Analysis:

a. Spirotetramat levels measured in the leaf extract samples were divided by the number of leaf discs in each sample to normalize spirotetramat concentration to the leaf area unit.
b. 100% of total applied spirotetramat reference for each treatment was calculated using the average of spirotetramat levels of the samples collected at two timepoints: immediately after the spraying and drying (0.5 hr) and after 2 days to represent amount of total applied spirotetramat on the unwashed leaves (see table 9)

TABLE 9
Spirotetramat levels recovered from the unwashed plants
representing 100% of applied spirotetramat to the leaves.

| | Spirotetramat |
|---|---|
| | concentration average |
| Treatment | [ppm] |
| Formulation A | 37.30 |
| Movento ® 100 SC | 35.24 |

The levels of Spirotetramat absorbed by the leaves at each timepoint were expressed as percentage of total applied Spirotetramat (% from total) for each treatment (Formulation A and Movento 100SC, respectively).

TABLE 10
Spirotetramat levels absorbed by the leaves.

| | | Formulation A | | Movento ® 100 SC | |
|---|---|---|---|---|---|
| | | Spirotetramat | | Spirotetramat | |
| Time | | concentration | | concentration | |
| point | | [ppm] | % from total | [ppm] | % from total |
| 0.5 | hr | 2.33 | 6.26 | 0.92 | 2.60 |
| 6 | hr | 2.69 | 7.22 | 1.25 | 3.55 |
| 12 | hr | 2.82 | 7.56 | 1.75 | 4.97 |
| 18 | hr | 3.22 | 8.62 | 1.93 | 5.49 |
| 24 | hr | 3.00 | 8.04 | 1.86 | 5.29 |
| 2 | days | 2.89 | 7.76 | 2.00 | 5.68 |
| 4 | days | 2.36 | 6.34 | 1.83 | 5.18 |
| 6 | days | 1.73 | 4.63 | 1.18 | 3.35 |

### Conclusions:

According to the SDS of Movento® 100 SC it comprises more than 1% and up to 25% of alkylarylpolyglycol ether (CAS 104376-75-2) while formulation A 480 SC (after 4.8 times dilution) comprises 0.77% of compound of formula (I), see tables 8 and 1.

It is clearly shown that the combination of spirotetramat and compound of formula (I) in formulation A results in better penetration to the leaf than the combination of spirotetramat with alkylarylpolyglycol ether in the commercial product Movento® 100 SC. Moreover, this effect is achieved while using lower amounts of the compound of formula (I) than the alkylarylpolyglycol in Movento® 100 SC.

1. A combination comprising an amount of a keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

2. The combination according to claim 1, wherein R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50.

3. The combination according to claim 1 or 2, wherein the keto-enol insecticide is selected from spirotetramat, spiromesifen, spirodiclofen, spiropidion and any combination thereof.

4. The combination according to any one of claims 1-3, wherein:
a. it is synergistic,
b. the amount of the compound of formula (I) improves the insecticidal efficacy of the amount of the keto-enol insecticide compared to when the same amount of the keto-enol insecticide is applied not in combination with the amount of compound of formula (I),
c. a substantially similar level of insecticidal efficacy is achieved by using a lesser amount of the compound of formula (I) and/or the keto-enol insecticide,
d. the amount of the compound of formula (I) is effective to increase sensitivity of the insect to the amount of the keto-enol insecticide compared to the sensitivity of the insect to the amount of the keto-enol insecticide when it applied not in combination with the amount of the compound of formula (I),
e. the amount of the compound of formula (I) is effective to increase the penetration of the amount of the keto-enol insecticide compared to the penetration of the amount of the keto-enol insecticide when it is applied not in combination with the amount of the compound of formula (I),
f. the combination is more effective in treating the plant or the locus against animal pests than when the keto-enol insecticide is applied alone at the same amount, and/or
g. the combination reduces the amount of time needed to achieve a level of animal pest control than when the amount of the keto-enol insecticide is applied alone.

5. The combination according to any one of claims 1-4, wherein the weight ratio between the total amount of the keto-enol insecticide to the total amount of the compound having the formula (I) is of about 90:1 to about 9:1.

6. The combination according to claim 5, wherein the weight ratio between the total amount of the keto-enol insecticide to the total amount of the compound having the formula (I) is of about 12:1.

7. The combination according to any one of claims 1-6, for use in reducing the amount of time needed to achieve a level of animal pest control.

8. The combination according to any one of claims 1-7, wherein the combination is a mixture.

9. A composition comprising keto-enol insecticide, a compound having the formula (I): R1-O—(CmH2mO)x-(CnH2nO)y-H R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and at least one agriculturally acceptable carrier.

10. The composition according to claim 9, wherein the amount of keto-enol insecticide is of about 10% to of about 60% by weight, based on the total weight of the composition and the amount of the compound having the formula (I) is of about 0.5% to of about 5% by weight, based on the total weight of the composition.

11. The composition according to claim 9 or 10, wherein the composition comprises at least one agriculturally acceptable additive selected from the group containing surfactants, solid diluents, liquid diluents, adjuvants and any combination thereof.

12. The composition according to any one of claims 9-11, wherein the weight ratio between the total amount of the keto-enol insecticide to the total amount of the compound having the formula (I) is of about 90:1 to about 9:1.

13. The composition according to any one of claims 9-12, wherein the keto-enol insecticide is selected from spirotetramat, spiromesifen, spirodiclofen, spiropidion and any combination thereof.

14. A method of treating a plant or a locus against animal pest infestation comprising applying a combination of an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to the plant or locus, wherein:
(i) the method is more effective against animal pest infestation than when the amount of the keto-enol insecticide is applied alone and/or
(ii) the amount of the compound having the formula (I) improves the insecticidal efficacy of the amount of the keto-enol insecticide compared to when the same amount of the keto-enol insecticide is applied not in combination with the amount of the compound having the formula (I).

15. A method for controlling animal pest comprising contacting the animal pest or its environment with an amount of keto-enol insecticide and an amount of a compound having the formula (I):
R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50.

16. A method for controlling animal pests comprising allowing an amount of keto-enol insecticide and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to act on pests and/or their habitat.

17. The method according to any one of claims 14-16, wherein the method reduces the amount of time needed to achieve a level of animal pest control than when the amount of the keto-enol insecticide is applied alone.

18. A method of reducing the amount of time needed to achieve a level of animal pest control from an application of an amount of keto-enol insecticide to a plant or locus comprising applying a combination of an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 and an amount of keto-enol insecticide to the plant or locus.

19. The method according to any claim 17 or 18, wherein the amount of time needed to achieve a level of animal pest control is less than 7 days post application.

20. The method according to any one of claims 17-19, wherein the amount of time needed to achieve a level of animal pest control is between 3 to 7 days post application.

21. The method according to any one of claims 14-20, wherein the weight ratio between the total amount of the keto-enol insecticide to the total amount of the compound having the formula (I) is of about 90:1 to about 9:1.

22. The method according to claim 21, wherein the weight ratio between the total amount of the keto-enol insecticide to the total amount of the compound having the formula (I) is of about 12:1.

23. The method according to any one of claims 14-22, wherein R1 is linear or branched, saturated or unsaturated acyl radical having from 16 to 18 carbon atoms, m is an integer equal to 2, n is an integer equal to 3, x is an integer of from 1 to 50 and y is an integer of from 0 to 50.

24. The method according to any one of claims 14-23, wherein R1 is oleate, m is an integer equal to 2, n is an integer equal to 3, x is an integer of from 1 to 50 and y is equal to 0.

25. The method according to any one of claims 14-24, wherein the keto-enol insecticide and the compound having the formula (I) are applied together, separately, simultaneously, contemporaneously, or successively.

26. The method according to any one of claims 14-25, wherein the keto-enol insecticide is selected from spirotetramat, spiromesifen, spirodiclofen, spiropidion and any combination thereof.

27. The method according to any one of claims 14-26, wherein the keto-enol insecticide and the compound having the formula (I) are applied as foliar application.

28. The method according to any one of claims 14-27, wherein the plant is selected from pomaceous fruit, stone fruit, soft fruit, apples, pears, avocado, plums, peaches, almonds, cherries, berries, strawberries, raspberries, blackberries, citrus fruit, oranges, lemons, grapefruit, tangerines, cucurbits, pumpkins, cucumbers, melons, lettuce, cabbages, carrots, tomatoes, potatoes, peppers, chilli, okra, eggplants, beans, peas, soya, oilseed rape, olives, sunflowers, ground nuts, cotton, nuts, coffee, grapevines, ornamentals or lauraceae.

29. The method according to any one of claims 14-28, wherein the animal pest is selected from the order of Lepidoptera, Diptera, Hemiptera, Thysanoptera, Coleoptera, Hymenoptera Heteroptera, Homoptera, Thysanoptera, acarine, nematode or mollusc.

30. A method for increasing the penetration of spirotetramat to a plant wherein the method comprises applying a combination comprising an amount of spirotetramat and an amount of a compound having the formula (I): R1-O—(CmH2mO)x-(CnH2nO)y-H wherein R1 is linear or branched, saturated or unsaturated acyl radical having from 14 to 20 carbon atoms; m is an integer equal to 2, n is an integer equal to 3, x is an integer of from 1 to 50 and y is an integer of from 0 to 50 to a plant locus.

31. The method according to claim 30, wherein R1 is linear or branched, saturated or unsaturated acyl radical having 18 carbon atoms; m is an integer equal to 2, n is an integer equal to 3, x is an integer of from 1 to 50 and y is an integer of from 0 to 50.

32. The method according to claim 30 or 31, wherein spirotetramat and the compound having the formula (I) are applied together, separately, simultaneously, contemporaneously, or successively.

33. The method according to anyone of claims 30-32, wherein the plant is selected from pomaceous fruit, stone fruit, soft fruit, apples, pears, avocado, plums, peaches, almonds, cherries, berries, strawberries, raspberries, blackberries, citrus fruit, oranges, lemons, grapefruit, tangerines, cucurbits, pumpkins, cucumbers, melons, lettuce, cabbages, carrots, tomatoes, potatoes, peppers, chilli, okra, eggplants, beans, peas, soya, oilseed rape, olives, sunflowers, ground nuts, cotton, nuts, coffee, grapevines, ornamentals or lauraceae.
